(19) United States
(12) Patent Application Publication
(10) Pub. No.: US 2001/0050902 A1
(43) Pub. Date: Dec. 13, 2001

(54) Radio communication system, radio communication apparatus, mobile communication terminal, base station apparatus and transmission power controlling method

(75) Inventor: Yutaka Asanuma, Tokyo (JP)

Correspondence Address: Finnegan, Henderson, Farabow, Garrett & Dunner, L.L.P., 1300 I street. N.W., Washington, DC, 20005-3315, US

(73) Assignee: KABUSHIKI KAISHA TOSHIBA

(21) Appl. No.: 09/866,736

(22) Filed: May 30, 2001

(30) Foreign Application Priority Data
May 31, 2000 (JP) 2000-163039

(51) Int. Cl. H04L 12/26; H04B 7/216

(52) U.S. Cl. 370/248; 370/252; 370/335

(57) ABSTRACT

A control cycle discriminating section sets a control cycle T of transmission power to be a short cycle Tl when the fluctuation rate S is lower than a reference value S1 or equal to or higher than a reference value S2, and sets the control cycle T to be a long cycle Ts when the fluctuation rate S is equal to or higher than the reference value S1 and lower than the reference value S2. A power controlling section controls transmission power of a transmitting section with the control cycle T. In a mobile station, a power detecting section averages reception power of a radio frequency (RF) signal transmitted from the base station, with the control cycle T, and measures the averaged reception power. A TPC bit generating section compares the measured power with a reference value, generates the TPC signal and transmits the TPC signal to the base station.

### BACKGROUND OF THE INVENTION

1. Field of the Invention

The present invention relates to transmission power control in a CDMA radio communication system.

2. Description of the Related Art

In a CDMA mobile communication system, the number of users to be connected to a base station is limited as an amount of interference influencing a radio frequency (RF) signal is increased. Thus, transmission power is controlled at a minimum level to minimize the interference.

When the transmission power becomes excessive, interference influencing other radio stations is increased and thereby capacity of the system is reduced. Exact control of the transmission power is one of very important controls for the CDMA mobile communication system.

Specifically, the transmission power is controlled by comparing power transmitted from a radio communication station with a reference value, transmitting a result of the comparison or a necessary amount of control obtained from the result of comparison to the radio communication station, and allowing the radio communication station to increase or reduce the transmission power.

In the mobile communication, transmission paths are changed during a short period due to Rayleigh fading. For this reason, it is thought that the transmission power should be controlled in a cycle of 0.5 to 1 millisecond if the mobile communication for an automobile moving at a high speed is considered.

Channel encoding, control of timing and the like need to be executed in digital communication employed in the CDMA mobile communication and, therefore, a format of a transmitted signal is based on a frame structure.

This structure allows transmission information and control information in each frame to be multiplexed and transmitted. The frame structure is often in a range from 5 to 100 milliseconds in accordance with the efficiency in channel encoding, transmission delay, and the like.

Accordingly, the control information in frames cannot be transmitted in a cycle necessary for the control of the transmission power. For this reason, a method of forming a further smaller unit called “slot” in each frame and transmitting a signal (TPC symbol) for transmission power at a slot interval is employed.

The TPC symbol is transmitted at a small interval and, therefore, only information of 1 to some bits can be transmitted by the TPC symbol. Generally, the TPC information of 1 bit is often transmitted in one slot. In this case, the TPC information is used as information that increases or reduces the transmission power by one step. Width of the step of the transmission power is predetermined by the control information transmitted by frame.

FIG. 1 shows a schematic diagram of a radio communication system for executing the control of transmission power by using the TPC symbol. A downstream line from a base station to a mobile station and an upstream line from the base station to the base station are set, between the base station and the mobile station. The control of the transmission power in the downstream line will be explained here as an example.

In the mobile station, a receiving section 2 receives a signal transmitted from the base station via an antenna 1 and a power detecting section 3 measures the power of the signal. A TPC bit generating section 4 compares the measured power with a reference value. The TPC bit generating section 4 generates a TPC signal to reduce the power if the power is larger than the reference value, or generates a TPC signal to increase the power if the power is smaller than the reference value.

A transmitting section 5 transmits the TPC signal thus generated to the base station via the antenna 1, on a control signal transmission channel of the upstream line. In the base station, a receiving section 12 receives the TPC signal on the control signal transmission channel via an antenna 11, and a TPC bit detecting section 13 detects the TPC signal. A power control section 14 increases or reduces transmission power of a transmitting section 15 on the basis of the result of the detection.

Power control in the upstream line is executed similarly to that in the downstream line, though the operations in the base station are replaced with those in the mobile station.

As explained above, in the control of the transmission power in the CDMA mobile communication, the control cycle is the slot interval, and the power increases or reduces with the step width predetermined in control cycles.

For this reason, there is always an error between the necessary transmission power and the actually controlled transmission power. If the error is great, transmission characteristics are deteriorated, for example, the capacity of the system is reduced and transmission quality is lowered.

The control cycle is set such that the error cannot be so great, in the system design. An optimum control cycle is varied in accordance with system parameters such as a fluctuation rate of the transmission path and the like. Therefore, recently, an architecture of determining a plurality of control cycles in one system and selecting the optimum one of the control cycles as determined by W-CDMA standard (3GPP TS25.214 “Physical Layer Procedure”, Section 5) has been developed. However, the standard does not include a specific guideline for the selection of one of the control cycles.

Incidentally, the channel encoding is often executed in the actual CDMA mobile communication system as mentioned above. In the channel encoding, fading characteristics can be improved by interleaving with the encoded data. Remarkable improvement of the characteristics can be seen when a fading rate is high enough, relative to an encoded frame length.

Therefore, an effect of error correction encoding needs to be considered for the selection of the control cycle and step width for the power control, but a guideline considering this point has not yet been determined.

### BRIEF SUMMARY OF THE INVENTION

The object of the present invention is to provide a radio communication system, a radio communication apparatus, a mobile communication terminal, a base station apparatus and a transmission power controlling method, capable of enhancing an effect of transmission power control by executing optimum change of a transmission power control cycle.

To achieve the object, the present invention of claim 1 provides a radio communication system capable of making connection in code division multiple access (CDMA) radio communication between a base station and a mobile station, for controlling a transmission power level in one of the base station and the mobile station in accordance with a reception power level in the other station, the radio communication system comprising: detector configured to detect a fluctuation rate of a transmission path; and controller configured to average a reception power level in a transmission signal of the one station received by the other station with a predetermined cycle and for controlling the transmission power level in the one station in accordance with the averaged reception power level, when the fluctuation rate detected by the detector is equal to or higher than a first threshold value and lower than a second threshold value, and to average the reception power level of the transmission signal of the one station received by the other station with a cycle longer than the predetermined cycle and for controlling the transmission power level in the one station in accordance with the averaged reception power level, when the fluctuation rate detected by the detector is lower than the first threshold value or equal to or higher than the second threshold value.

The present invention of claim 4 provides a transmission power controlling method for use in a radio communication system allowing a base station to make code division multiple access (CDMA) radio communication with a mobile station, for controlling a transmission power level in one of the base station and the mobile station in accordance with a reception power level in the other of the base station and the mobile station, the transmission power controlling method comprising the steps of: detecting a fluctuation rate of a transmission path; and averaging a reception power level of a transmission signal in the one station received by the other station with a predetermined cycle and controlling the transmission power level of the one station in accordance with the averaged reception power level, when the fluctuation rate detected at the detecting step is equal to or higher than a first threshold value and lower than a second threshold value, and averaging the reception power level of the transmission signal in the one station received by the other station with a cycle longer than the predetermined cycle and controlling the transmission power level of the one station in accordance with the averaged reception power level, when the fluctuation rate detected at the detecting step is lower than the first threshold value or equal to or higher than the second threshold value.

Further, the present invention of claim 7 provides a radio communication apparatus for making code division multiple access (CDMA) radio communication with a radio communication station, measuring a reception power level of a transmission signal from the radio communication station and allowing the radio communication station to control a transmission power level in the radio communication station in accordance with the measured reception power level, the radio communication apparatus comprising: first detector configured to detect a fluctuation rate of a transmission path with the radio communication station; second detector configured to average the reception power level of the transmission signal in the radio communication station with a predetermined cycle, when the fluctuation rate detected by the first detector is equal to or higher than a first threshold value and lower than a second threshold value, and for averaging the reception power level of the transmission signal of the radio communication station with a cycle longer than the predetermined cycle, when the fluctuation rate detected by the first detector is lower than the first threshold value or equal to or higher than the second threshold value; and transmitter configured to transmit information based on the reception power level obtained by the second detector to the radio communication station.

Moreover, the present invention of claim 10 provides a transmission power controlling method for use in a radio communication station making code division multiple access (CDMA) radio communication, for measuring a power level of a reception signal by the radio communication station and controlling a transmission power level of a transmitting station transmitting the received signal in accordance with the measured reception power level. The transmission power controlling method comprises first detection step of detecting a fluctuation rate of a transmission path with the radio communication station, second detection step of averaging the reception power level of the transmission signal of the radio communication station with a predetermined cycle, when the fluctuation rate detected at the first detection step is equal to or higher than a first threshold value and lower than a second threshold value, and averaging the reception power level of the transmission signal of the radio communication station with a cycle longer than the predetermined cycle, when the fluctuation rate detected at the first detection step is lower than the first threshold value or equal to or higher than the second threshold value, and transmission step of transmitting information based on the reception power level obtained at the second detection step to the radio communication station.

According to the above-constituted inventions, the fluctuation rate of the transmission path is detected, and when the fluctuation rate is equal to or higher than the first threshold value and lower than the second threshold value, the reception power level of the transmission signal from one station, which is received by the other station, is averaged with a predetermined cycle and the transmission power level of the former station is controlled in accordance with the averaged reception power level. When the fluctuation rate is lower than the first threshold value or equal to or higher than the second threshold value, the reception power level of the transmission signal is averaged with a cycle longer than the predetermined cycle and the transmission power level of the former station is controlled in accordance with the averaged reception power level.

That is, when the fluctuation rate is a low rate, which is lower than the first threshold value, a period for measurement of the reception power is made longer to reduce measurement errors caused by noise and increase accuracy of control. When the fluctuation rate is a high rate, which is equal to or higher than the first threshold value and lower than the second threshold value, the period for measurement of the reception power is made shorter to improve a follow-up operation for the high-rate fluctuation of the transmission and increase accuracy of control.

When the fluctuation rate is a further higher rate, which is equal to or higher than the second threshold value, the period for measurement of the reception power is made longer and a transmission power control optimum for distance fluctuation/shadowing fluctuation is executed by considering that the follow-up operation optimum for the fluctuation of the transmission path cannot be further executed or an effect of power control obtained from a follow-up operation to instantaneous fluctuation is lowered.

Therefore, according to the present invention, since the transmission power can be controlled with the control cycle optimum to each of the low, high and ultrahigh fluctuation rates of the transmission path, the effect of control of the transmission power can be further enhanced.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 shows a block diagram of a conventional radio communication system;

FIG. 2 shows a block diagram of a radio communication system according to an embodiment of the present invention;

FIG. 3 shows a relationship between a fluctuation rate of a transmission path and a cycle in transmission power control, in the radio communication system of FIG. 2;

FIG. 4 shows a sequence of operations of the transmission power control, in the radio communication system of FIG. 2;

FIG. 5 shows a fluctuation at a reception power level in a case where the fluctuation rate is low;

FIG. 6 shows a fluctuation at the reception power level in a case where the fluctuation rate is high;

FIG. 7 shows a fluctuation at the reception power level in a case where the fluctuation rate is ultrahigh;

FIG. 8 shows a graph explaining a relationship between the fluctuation rate and a ratio of a desired signal to an interference wave;

FIG. 9 shows a graph explaining a relationship between the fluctuation rate and the ratio of the desired signal to the interference wave, in error correction; and

FIG. 10 shows a block diagram of a radio communication system according to another embodiment of the present invention.

### DETAILED DESCRIPTION OF THE INVENTION

Embodiments of the present invention will be described below with reference to the drawings.

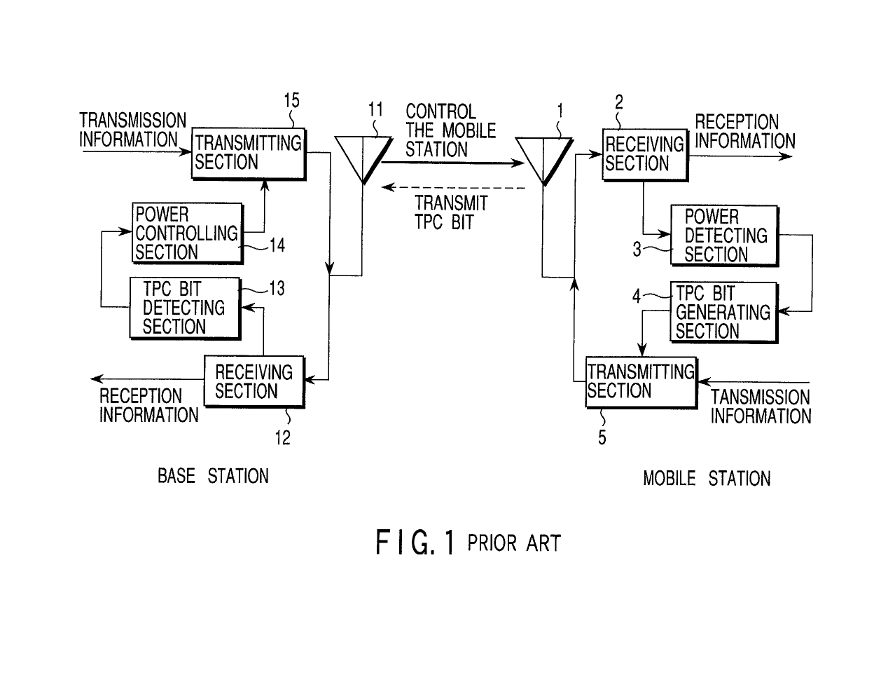

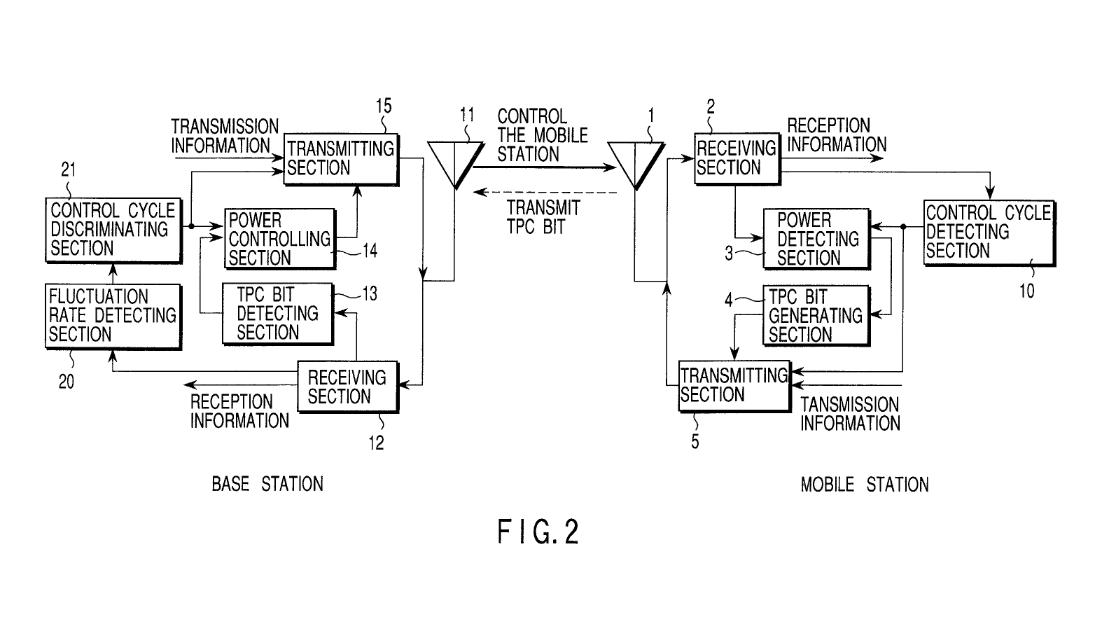

FIG. 2 shows a base station and a mobile station in a radio communication system according to an embodiment of the present invention. The same portions as those of the conventional radio communication system shown in FIG. 1 are denoted by the same reference numerals.

In the base station, a receiving section 12 receives a radio frequency (RF) signal transmitted from the mobile station via an antenna 11 and obtains the control data and speech data by demodulating the radio frequency (RF) signal.

A fluctuation rate detecting section 20 monitors the signal transmitted from the mobile station and received by the receiving section 12 and detects a fluctuation rate S of a transmission path between the base station and the mobile station on the basis of a fading cycle of the signal. Information of the detected fluctuation rate S is output to a control cycle discriminating section 21.

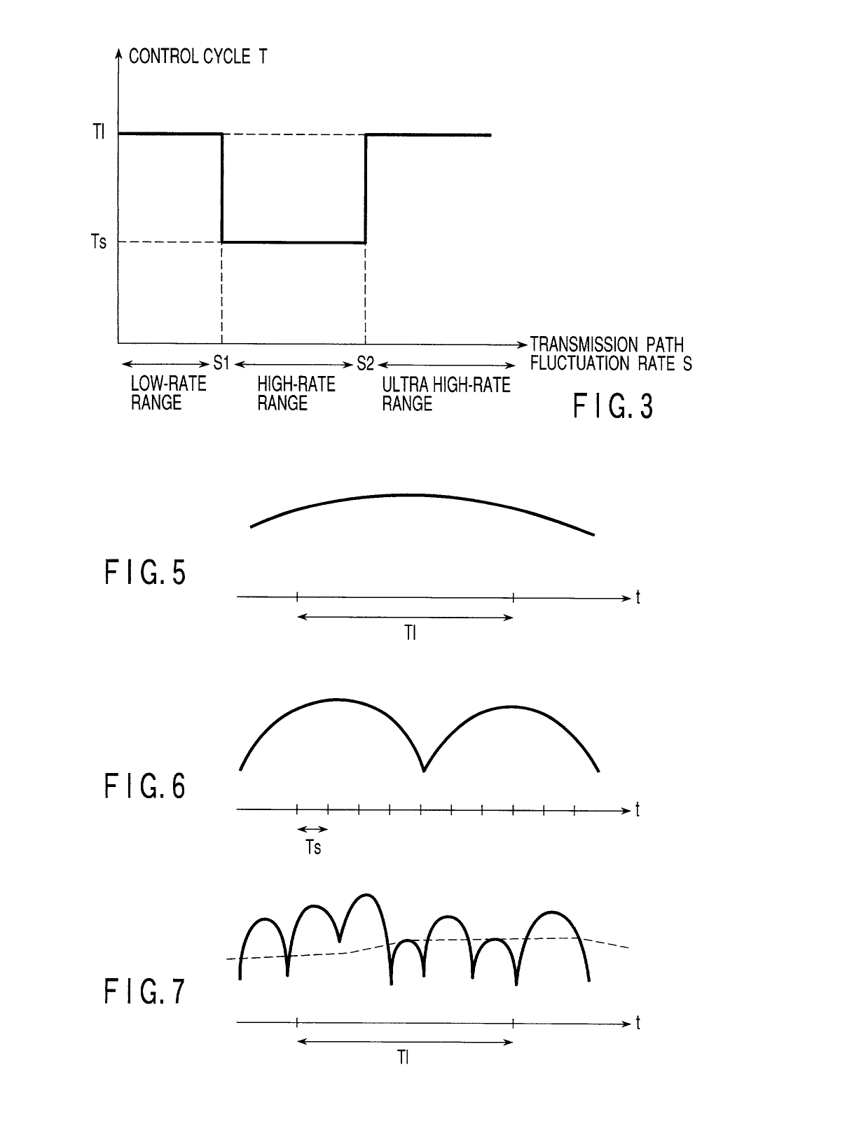

The control cycle discriminating section 21 discriminates a control cycle T of the transmission power on the basis of the fluctuation rate S detected by the fluctuation rate detecting section 20 and outputs information of the discriminated control cycle T to a power controlling section 14 and a transmitting section 15. FIG. 3 shows a relationship between the discriminated control cycle T of the transmission power and the fluctuation rate S.

As shown in FIG. 3, the control cycle T of the transmission power is set to be a short cycle Tl if the fluctuation rate S is lower than a reference value S1 or equal to or higher than a reference value S2. On the other hand, the control cycle T of the transmission power is set to be a long cycle Ts if the fluctuation rate S is equal to or higher than the reference value S1 and lower than the reference value S2.

A TPC bit detecting section 13 detects a TPC signal transmitted on the control signal transmission channel, of the signals transmitted from the mobile station and received by the receiving section 12, and outputs the TPC signal to the power controlling section 14.

The power controlling section 14 controls the transmission power of the transmitting section 15, with the control cycle T discriminated by the control cycle discriminating section 21, on the basis of the TPC signal detected by the TPC bit detecting section 13.

The transmitting section 15 transmits to the mobile station via the antenna 11, the transmission information such as speech data transmitted from the radio communication station of the mobile station and various kinds of control data including the control cycle T discriminated by the control cycle discriminating section 21.

In the mobile station, a receiving section 2 receives the radio frequency (RF) signal for the mobile station via an antenna 1, and demodulates the radio frequency (RF) signal to obtain the control data and speech data.

A control cycle detecting section 10 extracts information representing the control cycle T from the control information received by the receiving section 2 and outputs the information to a power detecting section 3 and a transmitting section 5.

The power detecting section 3 averages the reception power of the radio frequency (RF) signal transmitted from the base station with the control cycle T, measures the averaged reception power, and informs the measured reception power to a TPC bit generating section 4.

The TPC bit generating section 4 compares the measured reception power with a reference value. The TPC bit generating section 4 generates a TPC signal instructing the power reduction if the reception power is greater than the reference value or generates a TPC signal instructing the power increase if the reception power is smaller than the reference value. The TPC signal thus generated is output to the transmitting section 5.

The transmitting section 5 transmits the control data and the speech data with a radio frequency (RF) signal. The transmitting section 5 particularly transmits the TPC signal detected by the TPC bit detecting section 13 to the base station, on a control signal transmission channel, with a cycle corresponding to the control cycle T indicated by the information transmitted from the control cycle detecting section 10.

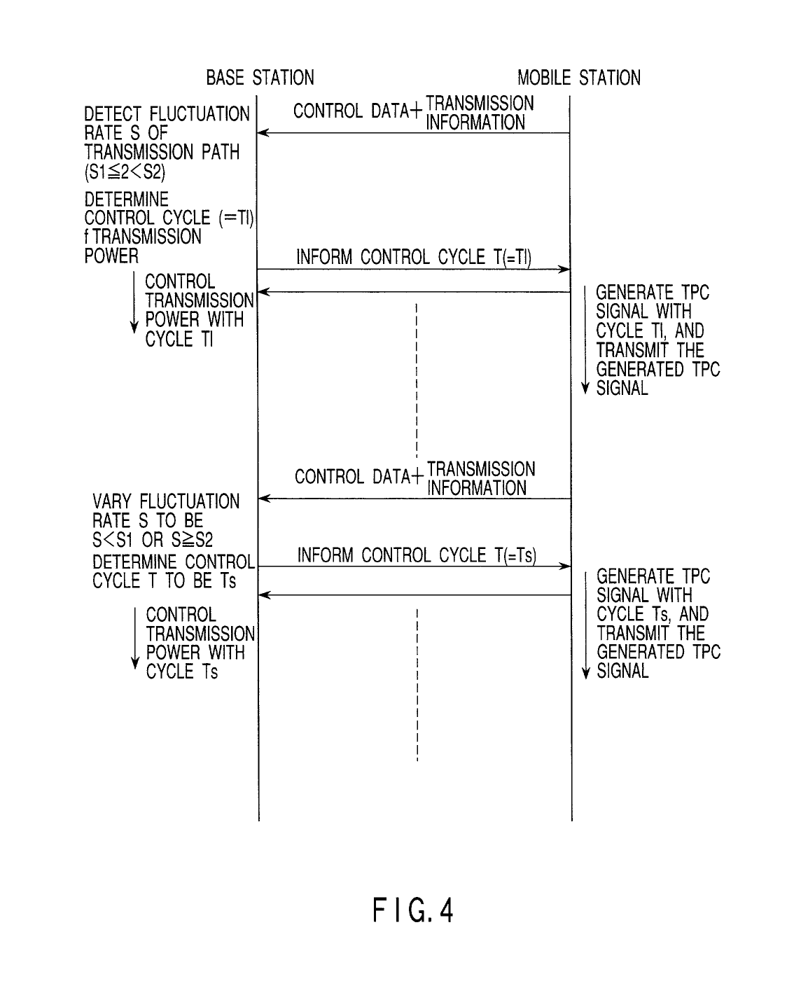

Next, varying operations of the transmission power control cycle in the above-constituted radio communication system will be described. FIG. 4 shows a sequence of the operations.

In the base station, the fluctuation rate detecting section 20 monitors the signal transmitted from the mobile station, and detects the fluctuation rate S of the transmission path between the base station and the mobile station on the basis of the fading cycle of the transmitted signal. It is assumed here that the fluctuation rate S is equal to or higher than the reference value S1 and lower than the reference value S2.

The control cycle discriminating section 21 determines the control cycle T of the transmission power on the basis of the detected fluctuation rate S. The control cycle T is determined to be Ts since the fluctuation rate S is equal to or higher than the reference value S1 and lower than the reference value S2.

The transmitting section 15 transmits the determined control cycle T to the mobile station, on the control signal transmission channel. After that, the base station controls the transmission power with the control cycle Ts.

When the control cycle detecting section 10 of the mobile station receives the control cycle T (=Ts) on the control signal transmission channel, the power detecting section 3 averages the reception power of the signal transmitted from the base station with this cycle and measures the averaged reception power.

The TPC bit generating section 4 compares the measured reception power with the reference value. The TPC bit generating section 4 generates a TPC signal instructing the power reduction if the reception power is greater than the reference value or generates a TPC signal instructing the power increase if the reception power is smaller than the reference value.

The TPC signal thus generated is transmitted to the base station on the control signal transmission channel, by the transmitting section 5. After that, in the mobile station, the power of the signal transmitted from the base station is averaged with the control cycle T and measured by the power detecting section 3, and the TPC signal is generated on the basis of the result of the measurement and transmitted to the base station, until the base station informs a new control cycle T to the mobile station.

If the fluctuation rate S detected by the fluctuation rate detecting section 20 is lower than the reference value S1 or equal to or higher than the reference value S2, the control cycle discriminating section 21 of the base station discriminates the control cycle of the transmission power to be Tl.

The new control cycle Tl is informed immediately to the mobile station on the control signal transmission channel. After that, the base station controls the transmission power with the new control cycle Tl.

In the mobile station informed of the new control cycle Tl, the power detecting section 3 averages the reception power of the signal transmitted from the base station with the new control cycle Tl and measures the averaged reception power.

The TPC bit generating section 4 compares the measured reception power with the reference value. The TPC bit generating section 4 generates a TPC signal instructing the power reduction if the reception power is greater than the reference value or generates a TPC signal instructing the power increase if the reception power is smaller than the reference value. The TPC signal thus generated is transmitted to the base station on the control signal transmission channel, by the transmitting section 5.

After that, in the mobile station, the power detecting section 3 averages the reception power of the signal transmitted from the base station with the control cycle T newly informed by the base station and measures the averaged power. The TPC signal is generated on the basis of the result of the measurement and transmitted to the base station.

As described above, in the above-constituted radio communication system, the transmission power is controlled on the basis of the measured value obtained by averaging the reception power with the comparatively long cycle Tl when the fluctuation rate S of the transmission path between the base station and the mobile station is a low rate, i.e. lower than the reference value S1 (FIG. 5) or an ultrahigh rate, i.e. equal to or higher than the reference value S2 (FIG. 7).

On the other hand, the transmission power is controlled on the basis of the measured value obtained by averaging the reception power with the comparatively short cycle TS when the fluctuation rate S is a high rate, i.e. equal to or higher than the reference value S1 and lower than the reference value S2 (FIG. 6).

That is, when the fluctuation rate S is a low rate, i.e. lower than the reference value S1, the period for measurement of the reception power is made longer to restrict a measurement error caused by noise and thereby increase accuracy in control. When the fluctuation rate S is a high rate, i.e. equal to or higher than the reference value S1 and lower than the reference value S2, the period for measurement of the reception power is made shorter to improve a follow-up operation for the high-rate fluctuation and thereby increase the accuracy in control.

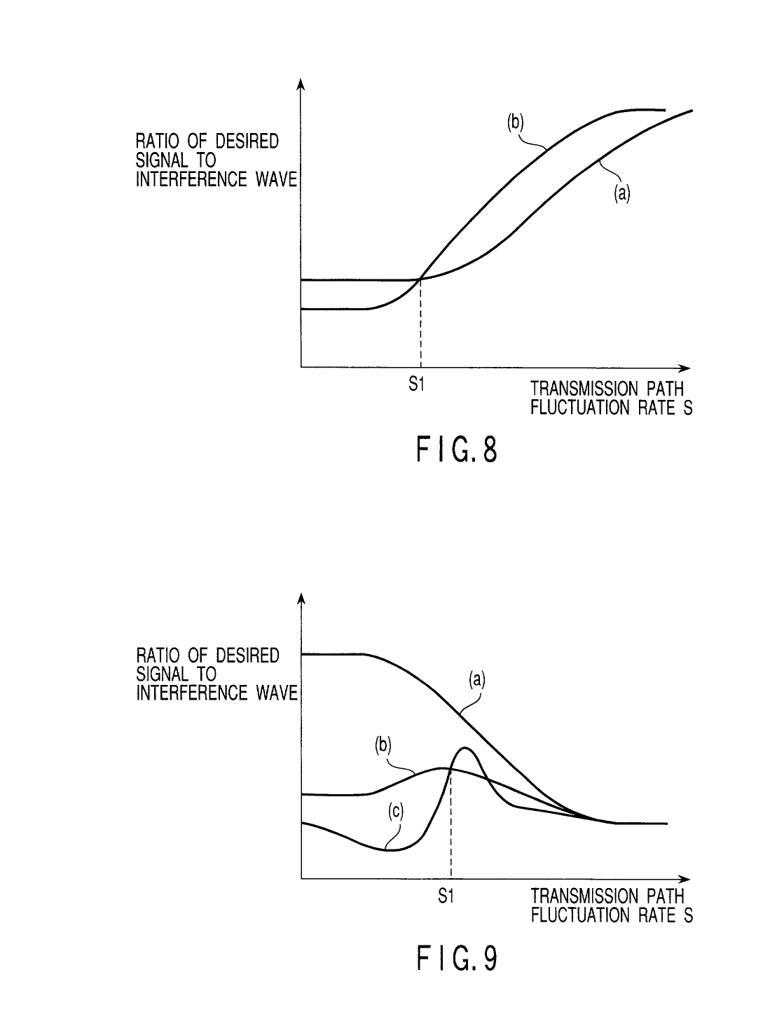

FIG. 8 shows a relationship between the fluctuation rate S and a ratio of a desired signal to an interference wave. Curve (a) represents a case where the control cycle T is short (T=TS) and curve (b) represents a case where the control cycle T= is long (T=Tl).

As shown in this figure, the longer control cycle represented by the curve (b) is effective in the low-rate range where the fluctuation rate is lower than the reference value S1. On the other hand, the shorter control cycle represented by the curve (a) is effective in the high-rate range where the fluctuation rate is higher than the reference value S1.

Next, a case where the transmitted signal is subjected to error correction and encoding, and interleaving will be explained. The transmission path fluctuation can be classified into instantaneous fluctuation in which the fluctuation rate is high, and distance fluctuation/shadowing fluctuation in which the fluctuation rate is 100 times lower than that of the instantaneous fluctuation.

First, the instantaneous fluctuation will be considered.

If the fluctuation rate is higher, the characteristic of the ratio of signal to interference which is necessary to satisfy certain desired quality, is improved because of interleaving effect, as represented by curve (a) in FIG. 9. The effect of the transmission power control becomes greater when the fluctuation rate is low, i.e. tracking to the transmission path is easy, or becomes smaller as the fluctuation rate is higher, as represented by the curve (a) or (b) in FIG. 8.

Accordingly, when the power control to the instantaneous fluctuation is executed, the characteristic of the curve (a) in FIG. 9 is synthesized with the characteristic of the curve (a) or (b) in FIG. 8. Examples of the synthesized characteristic are respectively represented by curves (b) and (c) in FIGS. 9.

The characteristics may be changed in various manners. As the fluctuation rate is higher, a difference between the characteristic in a case where the power control is executed to the instantaneous fluctuation and the characteristic in a case where the power control is not executed becomes smaller. That is, the effect of the power control on the instantaneous fluctuation can hardly be obtained, in the ultrahigh-rate range.

The distance fluctuation/shadowing fluctuation will be considered here.

When the power control is executed for the distance fluctuation/shadowing fluctuation, influence of the instantaneous fluctuation in the measured power deteriorates the accuracy in measurement. To reduce the influence, the period for measurement of the reception power may be made longer such that the influence of the instantaneous fluctuation is averaged.

In addition, influence of noise can be reduced if the period for measurement becomes longer as previously explained. Making the period for measurement longer, i.e. making the control cycle longer causes the tracking rate of the power control to the transmission path fluctuation to be lower. However, when the fluctuation rate of the transmission path is ultrahigh, the effect of the power control on the instantaneous fluctuation can hardly be obtained. Therefore, the effect on the distance fluctuation/shadowing fluctuation is improved, and the characteristic to be obtained by considering all the transmission path fluctuation is improved.

For the reasons as explained above, the power control cycle is varied in accordance with the fluctuation rate, and the control cycle in the low-rate range of the transmission path fluctuation is made longer than the control cycle in the high-rate range and the control cycle in the ultrahigh-rate range is made longer than the control cycle in the high-rate range, as shown in FIG. 3.

Therefore, according to the above-constituted radio communication system, since the transmission power is controlled with the control cycle optimum to each of the low, high and ultrahigh fluctuation rates of the transmission path, the effect of control of the transmission power can be further enhanced.

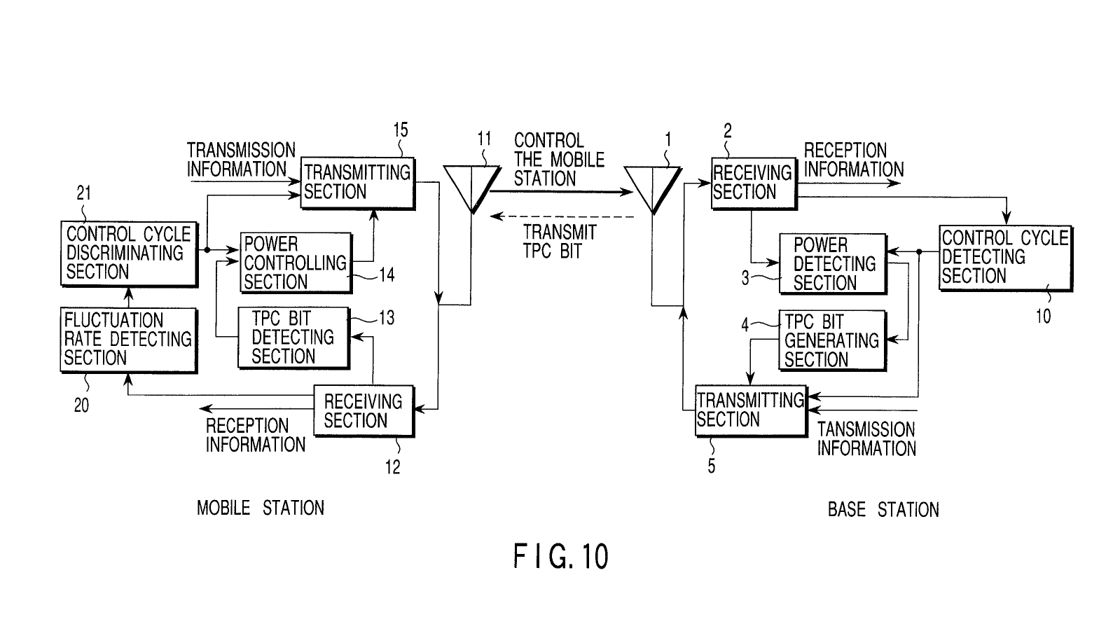

The present invention is not limited to the above-described embodiment. For example, the control of the transmission signal of the base station has been explained in the embodiment. The transmission power of the mobile station can be controlled by replacing the mobile station with the base station as shown in FIG. 10.

In addition, the control cycle is set to be Tl when the fluctuation rate S detected by the fluctuation rate detecting section 20 is lower than the reference value S1, and the control cycle is also set to be Tl when the fluctuation rate S is equal to or higher than the reference value S2. However, the present invention is not limited to this. Different control cycles may be set in those cases if they are longer than the control cycle Ts.

Moreover, the fluctuation rate is detected on the base station side, which controls the transmission power. However, the fluctuation rate may be detected on the mobile station side. In this case, the fluctuation rate may be detected, not from the cycle of fading, but from a result of detection of a moving speed detector provided on the mobile station (for example, a speedometer of an automobile).

The present invention can be variously modified in a range that does not exceed the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio communication system capable of making connection in code division multiple access (CDMA) radio communication between a base station and a mobile station, for controlling a transmission power level in one of said base station and said mobile station in accordance with a reception power level in the other station, said radio communication system comprising:
detector configured to detect a fluctuation rate of a transmission path; and
controller configured to average a reception power level in a transmission signal of said one station received by said other station with a predetermined cycle and for controlling the transmission power level in said one station in accordance with said averaged reception power level, when the fluctuation rate detected by said detector is equal to or higher than a first threshold value and lower than a second threshold value, and to average the reception power level of the transmission signal of said one station received by said other station with a cycle longer than said predetermined cycle and for controlling the transmission power level in said one station in accordance with said averaged reception power level, when the fluctuation rate detected by said detector is lower than the first threshold value or equal to or higher than the second threshold value.

2. A radio communication system capable of making connection in code division multiple access (CDMA) radio communication between a base station and a mobile station, for controlling a transmission power level in said mobile station in accordance with a reception power level in said base station, said radio communication system comprising:
detector configured to detect a fluctuation rate of a transmission path; and
controller configured to average a reception power level in a transmission signal of said mobile station received by said base station with a predetermined cycle and for controlling the transmission power level in said mobile station in accordance with said averaged reception power level, when the fluctuation rate detected by said detector is equal to or higher than a first threshold value and lower than a second threshold value, and for averaging the reception power level of the transmission signal in said mobile station received by said base station with a cycle longer than said predetermined cycle and for controlling the transmission power level of said mobile station in accordance with said averaged reception power level, when the fluctuation rate detected by said detector is lower than the first threshold value or equal to or higher than the second threshold value.

3. A radio communication system capable of making connection in code division multiple access (CDMA) radio communication between a base station and a mobile station, for controlling a transmission power level of said base station in accordance with a reception power level in said mobile station, said radio communication system comprising:
detector configured to detect a fluctuation rate of a transmission path; and
controller configured to average a reception power level of a transmission signal in said base station received by said mobile station with a predetermined cycle and for controlling the transmission power level of said base station in accordance with said averaged reception power level, when the fluctuation rate detected by said detector is equal to or higher than a first threshold value and lower than a second threshold value, and for averaging the reception power level of the transmission signal in said base station received by said mobile station with a cycle longer than said predetermined cycle and for controlling the transmission power level of said base station in accordance with said averaged reception power level, when the fluctuation rate detected by said detector is lower than the first threshold value or equal to or higher than the second threshold value.

4. A transmission power controlling method for use in a radio communication system allowing a base station to make code division multiple access (CDMA) radio communication with a mobile station, for controlling a transmission power level in one of said base station and said mobile station in accordance with a reception power level in the other of said base station and said mobile station, said transmission power controlling method comprising the steps of:
detecting a fluctuation rate of a transmission path; and
averaging a reception power level of a transmission signal in said one station received by said other station with a predetermined cycle and controlling the transmission power level of said one station in accordance with said averaged reception power level, when the fluctuation rate detected at said detecting step is equal to or higher than a first threshold value and lower than a second threshold value, and averaging the reception power level of the transmission signal in said one station received by said other station with a cycle longer than said predetermined cycle and controlling the transmission power level of said one station in accordance with said averaged reception power level, when the fluctuation rate detected at said detecting step is lower than the first threshold value or equal to or higher than the second threshold value.

5. A transmission power controlling method for use in a radio communication system allowing a base station to make code division multiple access (CDMA) radio communication with a mobile station, for controlling a transmission power level in said mobile station in accordance with a reception power level in said base station, said transmission power controlling method comprising the steps of:
detecting a fluctuation rate of a transmission path; and
averaging a reception power level of a transmission signal in said mobile station received by said base station with a predetermined cycle and controlling the transmission power level in said mobile station in accordance with said averaged reception power level, when the fluctuation rate detected at said detecting step is equal to or higher than a first threshold value and lower than a second threshold value, and averaging the reception power level of the transmission signal in said mobile station received by said base station with a cycle longer than said predetermined cycle and controlling the transmission power level of said mobile station in accordance with said averaged reception power level, when the fluctuation rate detected at said detecting step is lower than the first threshold value or equal to or higher than the second threshold value.

6. A transmission power controlling method, for use in a radio communication system allowing a base station to make code division multiple access (CDMA) radio communication with a mobile station, for controlling a transmission power level of said base station in accordance with a reception power level of said mobile station, said transmission power controlling method comprising the steps of:
detecting a fluctuation rate of a transmission path; and
averaging a reception power level of a transmission signal in said base station received by said mobile station with a predetermined cycle and controlling the transmission power level in said base station in accordance with said averaged reception power level, when the fluctuation rate detected at said detecting step is equal to or higher than a first threshold value and lower than a second threshold value, and averaging the reception power level of the transmission signal in said base station received by said mobile station with a cycle longer than said predetermined cycle and controlling the transmission power level in said base station in accordance with said averaged reception power level, when the fluctuation rate detected at said detecting step is lower than the first threshold value or equal to or higher than the second threshold value.

7. A radio communication apparatus for making code division multiple access (CDMA) radio communication with a radio communication station, measuring a reception power level of a transmission signal from said radio communication station and allowing said radio communication station to control a transmission power level in said radio communication station in accordance with said measured reception power level, said radio communication apparatus comprising:
first detector configured to detect a fluctuation rate of a transmission path with said radio communication station;
second detector configured to average the reception power level of the transmission signal in said radio communication station with a predetermined cycle, when the fluctuation rate detected by said first detector is equal to or higher than a first threshold value and lower than a second threshold value, and for averaging the reception power level of the transmission signal of said radio communication station with a cycle longer than said predetermined cycle, when the fluctuation rate detected by said first detector is lower than the first threshold value or equal to or higher than the second threshold value; and
transmitter configured to transmit information based on the reception power level obtained by said second detector to said radio communication station.

8. A mobile communication terminal for making code division multiple access (CDMA) radio communication with a base station, measuring a reception power level of a transmission signal from said base station and allowing said base station to control a transmission power level in said radio communication station in accordance with said measured reception power level, said mobile communication terminal comprising:
first detector configured to detect a fluctuation rate of a transmission path with said base station;
second detector configured to average the reception power level of the transmission signal in said base station with a predetermined cycle, when the fluctuation rate detected by said first detector is equal to or higher than a first threshold value and lower than a second threshold value, and for averaging the reception power level of the transmission signal in said base station with a cycle longer than said predetermined cycle, when the fluctuation rate detected by said first detector is lower than the first threshold value or equal to or higher than the second threshold value; and
transmitter configured to transmit information based on the reception power level obtained by said second detector to said base station.

9. A base station apparatus for making code division multiple access (CDMA) radio communication with a mobile station, measuring a reception power level of a transmission signal from said mobile station and allowing said mobile station to control a transmission power level in said radio communication station in accordance with said measured reception power level, said base station apparatus comprising:
first detector configured to detect a fluctuation rate of a transmission path with said mobile station;
second detector configured to average the reception power level of the transmission signal in said mobile station with a predetermined cycle, when the fluctuation rate detected by said first detector is equal to or higher than a first threshold value and lower than a second threshold value, and for averaging the reception power level of the transmission signal in said mobile station with a cycle longer than said predetermined cycle, when the fluctuation rate detected by said first detector is lower than the first threshold value or equal to or higher than the second threshold value; and
transmitter configured to transmit information based on the reception power level obtained by said second detector to said mobile station.

10. A transmission power controlling method for use in a radio communication station making code division multiple access (CDMA) radio communication, for measuring a power level in a reception signal by said radio communication station and controlling a transmission power level in a transmitting station transmitting said received signal in accordance with said measured reception power level, said transmission power controlling method comprising:
first detection step of detecting a fluctuation rate of a transmission path with said radio communication station;
second detection step of averaging the reception power level of the transmission signal in said radio communication station with a predetermined cycle, when the fluctuation rate detected at said first detection step is equal to or higher than a first threshold value and lower than a second threshold value, and averaging the reception power level of the transmission signal in said radio communication station with a cycle longer than said predetermined cycle, when the fluctuation rate detected at said first detection step is lower than the first threshold value or equal to or higher than the second threshold value; and
transmission step of transmitting information based on the reception power level obtained at said second detection step to said radio communication station.

11. A transmission power controlling method for use in a mobile station which is connected to a base station by code division multiple access (CDMA) radio communication, for measuring a power level of a signal received from said base station and controlling a transmission power level of said base station in accordance with said measured reception power level, said transmission power controlling method comprising:
first detection step of detecting a fluctuation rate of a transmission path with said base station;
second detection step of averaging the reception power level of the transmission signal in said base station with a predetermined cycle, when the fluctuation rate detected at said first detection step is equal to or higher than a first threshold value and lower than a second threshold value, and averaging the reception power level of the transmission signal in said base station with a cycle longer than said predetermined cycle, when the fluctuation rate detected at said first detection step is lower than the first threshold value or equal to or higher than the second threshold value; and
transmission step of transmitting information based on the reception power level obtained at said second detection step to said base station.

12. A transmission power controlling method for use in a base station connected to a mobile station by code division multiple access (CDMA) radio communication, for measuring a power level of a signal received from said mobile station and controlling a transmission power level of said mobile station in accordance with said measured reception power level, said transmission power controlling method comprising:
first detection step of detecting a fluctuation rate of a transmission path with said mobile station;
second detection step of averaging the reception power level of the transmission signal in said mobile station with a predetermined cycle, when the fluctuation rate detected at said first detection step is equal to or higher than a first threshold value and lower than a second threshold value, and averaging the reception power level of the transmission signal in said mobile station with a cycle longer than said predetermined cycle, when the fluctuation rate detected at said first detection step is lower than the first threshold value or equal to or higher than the second threshold value; and
transmission step of transmitting information based on the reception power level obtained at said second detection step to said mobile station.
